(19) United States
(12) Patent Application Publication
(10) Pub. No.: US 2025/0119899 A1
(43) Pub. Date: Apr. 10, 2025

(54) SCHEDULING RADIO RESOURCES FOR INDUSTRIAL DEVICES IN INDUSTRIAL ENVIRONMENT

(71) Applicant: TELEFONAKTIEBOLAGET LM ERICSSON (PUBL), Stockholm (SE)

(72) Inventors: Ari KERÄNEN, Helsinki (FI); Géza SZABÓ, Kecskemét (HU); Roman CHIRIKOV, Stockholm (SE)

(21) Appl. No.: 18/833,166

(22) PCT Filed: Jan. 27, 2022
(86) PCT No.: PCT/SE2022/050085

§ 371 Date: Jul. 25, 2024

(51) Int. Cl. H04W 72/121; H04W 72/51; H04W 72/52; H04W 72/54

(52) U.S. Cl. CPC H04W 72/121; H04W 72/51; H04W 72/52; H04W 72/54

(57) ABSTRACT

Embodiments of the present disclosure provide a method for scheduling radio resources for a plurality of industrial devices in an industrial environment. The method is performed by a network node in the wireless communication network. The method includes receiving input data including one or more of: device characteristic information of the plurality of industrial devices, information indicating a state of each industrial device, and information related to one or more command messages to be transmitted to the industrial devices. The method includes estimating data traffic among the plurality of industrial devices using the input data. The method further includes scheduling the radio resources for the plurality of industrial devices in accordance with the data traffic among the plurality of industrial devices.

### TECHNICAL FIELD

The present disclosure relates generally to an industrial environment. More particularly, it relates to methods, network node, and computer program products for scheduling of radio resources for industrial devices in the industrial environment.

### BACKGROUND

Industrial automation is becoming increasingly popular due to rapid development in sensors, control system, and other manufacturing techniques. As industrial environment such as factories become smarter and more agile, i.e. the production processes can be adjusted based on the product demands, product customization, and equipment availability. To enable such agility in industrial devices such as manufacturing robots have to be able to perform different tasks. This can be achieved by a modular architecture of industrial devices when more modules can be added if needed and use different tools (e.g. drill, cutter, gripper, fan, heater, etc.). Such a modular architecture has high demands on the communication between the industrial devices, but also propagation in the industrial environment becomes more variable as different industrial devices may produce undesired interference.

Currently, the radio resources are scheduled for the communication based on a number of inputs, such as network load, channel measurements, available bandwidth, etc. In such scenarios, highly reliable packet delivery relies on retransmission techniques. Such approach is efficient when the data traffic is unknown and variable, interference is random, and channels change rapidly. However, in the closed environments, such as the industrial environment, the traditional approaches might not always lead to the most efficient use of resources. Thus, the network performance is not optimal in the limited bandwidth availability.

The efficient use of the radio resources for communication among the industrial controller and the industrial devices is crucial for industrial task execution.

### SUMMARY

Consequently, there is a need for an improved method and arrangement for scheduling radio resources for a plurality of industrial devices in the industrial environment that alleviates at least some of the above cited problems.

It is therefore an object of the present disclosure to provide a method, a network node and a computer program product for scheduling radio resources for a plurality of industrial devices in an industrial environment to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclosure, a method for scheduling radio resources for a plurality of industrial devices in an industrial environment is disclosed. The method is performed by a network node in the wireless communication network. The method comprises receiving input data comprising one or more of: device characteristic information of the plurality of industrial devices, information indicating a state of each industrial device, and information related to one or more command messages to be transmitted to the industrial devices. The method comprises estimating data traffic among the plurality of industrial devices using the input data. The method further comprises scheduling the radio resources for the plurality of industrial devices in accordance with the data traffic among the plurality of industrial devices.

In some embodiments, the input data is received from one or more of: a repository associated with the industrial environment, each industrial device, and an industrial controller executing an industrial application configured to generate one or more command messages for controlling the industrial device.

In some embodiments, the device characteristic information comprises one or more of: one or more properties of the industrial devices, a capability of each industrial device to perform an assigned task, a material used in a manufacturing of the industrial device, compatibility of the industrial devices with each other, a location of the industrial device, information about a protocol stack of an industrial application executed in an industrial controller controlling the industrial devices, latency requirement for the industrial devices, and spectral density of an electromagnetic field produced by the industrial device.

In some embodiments, the information indicating the state of the industrial device comprises one or more of: a current location of the industrial device, a connection with each industrial device, and an orientation of the industrial device.

In some embodiments, the step of receiving input data comprising transmitting a request message for the input data to one or more of the repository, the plurality of industrial devices, and the industrial controller. The method further comprising receiving the input data in response to the request message.

In some embodiments, the step of estimating the data traffic among the plurality of industrial devices using the input data comprising obtaining information related to ongoing communications among the plurality of industrial devices from the information indicating configuration of each industrial device and acquiring latency requirement for the one or more command messages. The method further comprises analyzing the information related to ongoing communications among the plurality of industrial devices in accordance with the latency requirement for the one or more command messages and estimating the data traffic among the plurality of industrial devices based on the analysis.

In some embodiments, the step of scheduling the radio resources for the plurality of industrial devices in accordance with the data traffic among the plurality of industrial devices comprising detecting presence of at least one object between the plurality of industrial devices. The at least one object causing an interference in transmission of data between the industrial devices. The method comprising obtaining information associated with the at least one object. The information comprising one or more of: a type of each object and a type of interference caused by each object. The method further comprising determining an impact of the interference on the industrial devices based on the object information, identifying a set of frequencies for which the interference is caused by the at least one object, and scheduling the radio resources by avoiding the identified set of frequencies.

According to a second aspect of the present disclosure, an apparatus of a network node configured to operate in a wireless communication network for scheduling radio resources for a plurality of industrial devices in an industrial environment is provided. The apparatus comprising controlling circuitry configured to cause reception of input data comprising one or more of: device characteristic information of the plurality of industrial devices, information indicating a state of each industrial device, and information related to one or more command messages to be transmitted to the industrial devices. The controlling circuitry is configured to cause estimation of data traffic among the plurality of industrial devices using the input data. Further, the controlling circuitry is configured to cause scheduling of the radio resources for the plurality of industrial devices in accordance with the data traffic among the plurality of industrial devices.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for scheduling radio resources for a plurality of industrial devices in an industrial environment.

An advantage of some embodiments is that the efficiency of radio resource usage is increased in the industrial environment.

An advantage of some embodiments is the scheduling of radio resources is efficient in a shared medium for industrial devices.

An advantage of some embodiments is that the command messages are transmitted to the industrial device in accordance with the information about the industrial environment. Thus, the radio resources are used efficiently by the network node.

An advantage of some embodiments is that the radio resources are scheduled in accordance with the data traffic among the industrial devices.

An advantage of some embodiments is that the spectral efficiency of wireless communication network is increased in the industrial environment.

An advantage of some embodiments is that improved approaches are provided for mitigating the performance degradation or failed operations in the industrial environment.

An advantage of some embodiments is that capital expenditures are saved by efficient usage of radio spectrum.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of an industrial environment according to some embodiments;

FIG. 2 is a signalling diagram illustrating example signalling according to some embodiments;

FIG. 3 is a flowchart illustrating example method steps according to some embodiments;

FIG. 4 is a schematic block diagram illustrating an example apparatus according to some embodiments; and

FIG. 5 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

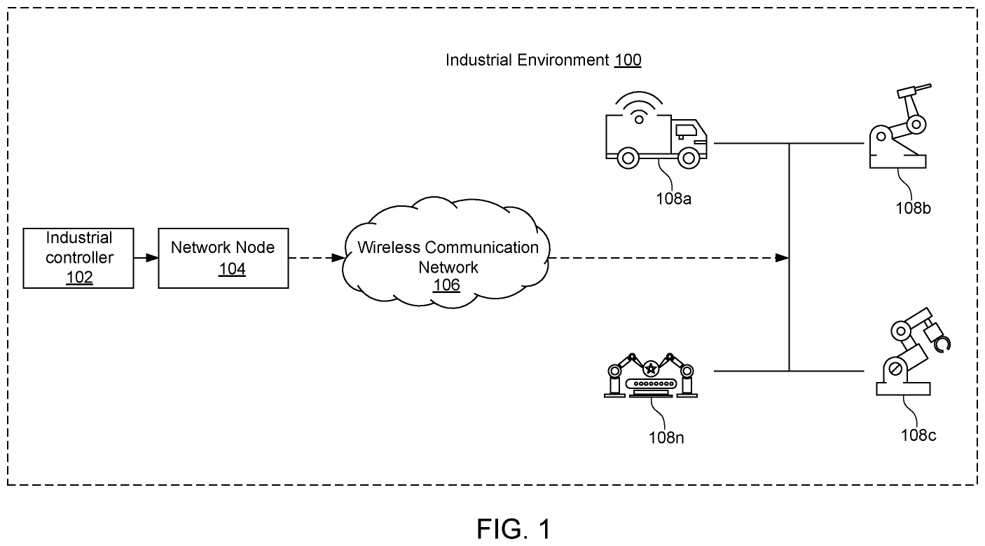

FIG. 1 discloses an industrial environment 100. Some of the examples of the industry environment 100 may include a factory, a manufacturing unit, guided robotic environment, etc. The industrial environment 100 comprises an industrial controller 102, a network node 104 and industrial devices 108a, 108b, 108c and so on to 108n. Examples of the industrial devices 108a-108n may comprise Articulated Robots, Cartesian Robots, Selective Compliance Assembly Robot Arm, Delta robots, Polar robots, a 6-DOF robotic arm, collaborating robotic arms, Automated Guided Vehicles, AGVs, with omni-wheels, or other robotic devices. The network node 102 communicates with a plurality of industrial devices 108a-108n through a wireless communication network 106 for controlling the plurality of industrial devices 108a-108n. For example, the plurality of industrial devices 108a-108n is configured to receive command messages from the industrial controller 102 through the network node 104 in the wireless communication network 106. For example, the network node 104 may be a radio access network comprising a plurality of base stations or evolved node base stations (not shown) or the internet using one or more suitable communication protocols for scheduling the radio resources for transmission of command messages to the plurality of industrial devices 108a-108n.

The industrial controller 102 is configured to generate command messages intended for controlling the industrial devices 108a-108n. The network node 104 is configured to acquire the command messages from the industrial controller 102. The command messages may be generated by an industrial application executed in the industrial controller 102. Further, the network node 104 transmits the command messages to the industrial devices 108a-108n through the wireless communication network 106. The industrial devices 108a-108n is configured to receive the command messages from the network node 104. The command messages may comprise one or more commands intended for the industrial devices 108a-108n to execute an assigned task. For example, the industrial devices 108a-108n comprise one or more actuators (e.g. servos, arms, wheels, or the like) that are controlled according to the commands. The assigned task can be performed by using different modules installed in the industrial devices 108a-108n. This leads to use of a modular architecture of the industrial devices. It should be noted that the industrial environment 100 is not limited to above-mentioned components, other components can also be present in the industrial environment 100 other than the component shown in the FIG. 1.

Such a modular architecture has high demands on the communication between the industrial devices 108a-108n, but also propagation in the industrial environment 100 becomes more variable as different industrial devices 108a-108n may produce undesired interference. In the closed environments, such as the industrial environment 100, the network performance is not optimal when there is a limited bandwidth availability. Thus, the efficient use of the radio resources for communication among the industrial devices is crucial in industrial task execution.

Therefore, according to some embodiments of the present disclosure, the network node 104 implements a method for scheduling radio resources for the plurality of industrial devices 108a-108n in an industrial environment 100.

According to some embodiments of the present disclosure, the network node 104 receives input data comprising one or more of device characteristic information of the plurality of industrial devices 108a-108n, information indicating a state of each industrial device 108a-108n, and information related to one or more command messages to be transmitted to the industrial devices 108a-108n. For example, the network node 104 receives the characteristic information from a repository configured to store information related to the industrial devices 108a-108n. The network node 104 receives the information indicating the state of each industrial device 108a-108n. Further, the network node 104 receives the information related to one or more command messages to be transmitted to the industrial devices 108a-108n, from the industrial controller 102.

Further, the network node 104 estimates data traffic among the plurality of industrial devices 108a-108n using the input data. For example, the network node 104 analyses the device characteristic information of the plurality of industrial devices 108a-108n, the information indicating the state of each industrial device 108a-108n, and the information related to one or more command messages to be transmitted to the industrial devices 108a-108n. Further, the network node 104 estimates the data traffic based on the analysis of the input data.

The network node 104 schedules the radio resources for the plurality of industrial devices 108a-108n in accordance with the estimated data traffic among the plurality of industrial devices 108a-108n. For example, the network node 104 assigns the radio resources to the industrial devices 108a-108n in accordance with the data traffic among the plurality of industrial devices 108a-108n.

The network node 104 may intelligently schedules the radio resources by analysing the additional inputs about the industrial environment 100. For example, the network node 104 may consider the details about the industrial devices 108a-108n, the state of the industrial devices 108a-108n and details about the command messages in scheduling the radio resources for the industrial devices 108a-108n. Further, the network node 104 may consider at least one object e.g. physical dimensions and material of an object that could block direct line of sight communication options or usage of a module (e.g. a robotic arm or a servo) that is known to cause interference in a certain set of radio frequencies such that those frequencies can be avoided when the module is used. Altogether, such use of additional inputs can help networks operate more efficiently and require less resources and enable more effective use of the resources by the network node 104.

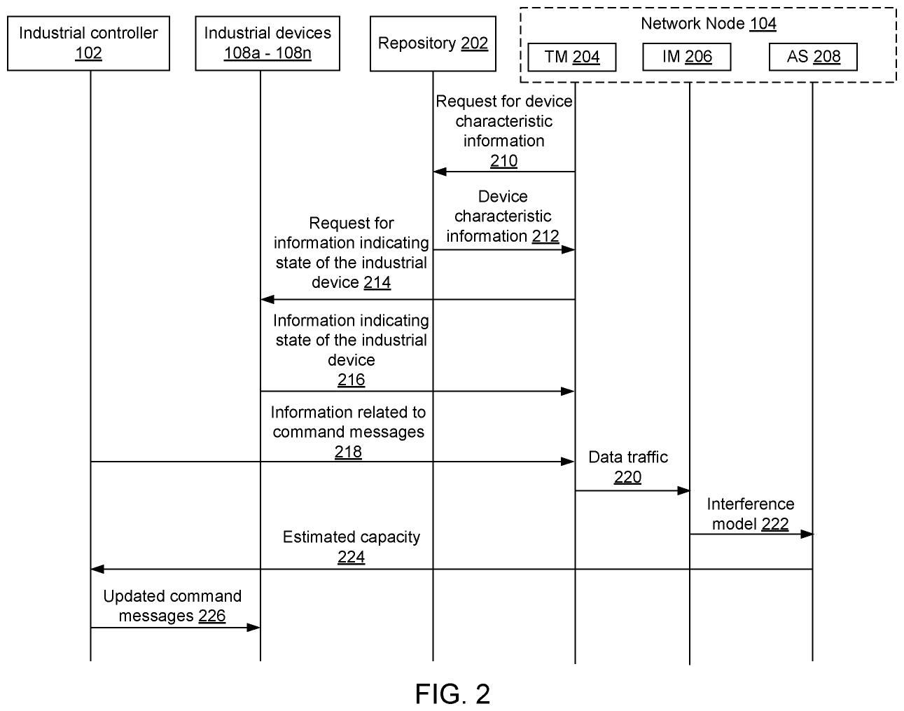

FIG. 2 is a signalling diagram illustrating example signalling for scheduling radio resources for a plurality of industrial devices 108a-108n in the industrial environment. The network node 104 includes a Traffic Modeler, TM, 204, an Interference Modeler, IM, 206, and an Advanced Modeler, AS, 208.

The TM 204 transmits 210 a request message for the device characteristic information to a repository 202. The repository 202 is a directory such as Directory of robots and robotic modules, DRM, that stores information about the available industrial devices 108a-108n. Examples of the device characteristic information may include one or more of properties of the industrial devices 108a-108n, a capability of the industrial device 108a-108n to perform the assigned task, a material used in a manufacturing process if the industrial device 108a-108n, compatibility of the industrial device 108a-108n with each other, a location of the industrial device 108a-108n, information about a protocol stack of an industrial application executed in an industrial controller controlling the industrial devices 108n-108n, latency requirements for the industrial devices 108a-108n, spectral density of an electromagnetic field produced by the industrial device 108a-108n, or the like. Further, the repository comprises an asset manager that may track one or more of the industrial devices 108a-108n from a multi-directional aspect including load carrying capacity, accuracy, repeatability, actuator direction (linear/rotational), radio absorption level, electrical conduction, magnetic property, waterproof, food industry/healthcare compatible cleanness, visual transparency, material, mesh description of the industrial device, or the like.

The repository 202 transmits 212 the device characteristic information to the TM 204. The TM 204 may analyze the device characteristic information and extracts the required details from the device characteristic information. The TM 204 identifies one or more industrial devices 108a-108n available in the industrial environment. Further, the TM 204 transmits 214 a request for information related to the state of each industrial device 108a-108n based on the device characteristic information. The request for the information related to the state of each industrial device 108a-108n may comprise required details of each identified industrial device 108a-108n. Each industrial device 108a-108n receives the request for the state.

Further, each industrial device 108a-108n transmits 216 the information indicating the state of each industrial device 108a-108n to the TM 204. Examples of the information related to the state of each industrial device 108a-108n may comprise one or more of a current location of the industrial device 108a-108n, a connection with each industrial device, and an orientation of the industrial device 108a-108n, or the like. The plurality of industrial devices 108a-108n may communicate with each other and may impact the communication capabilities of each other.

The industrial controller 102 transmits 218 information related to one or more command messages intended for controlling the industrial device 108a-108n to the TM 204. For example, the information related to the one or more command messages may comprise one or more of type of command, details about different components need to exchange while executing the command, bandwidth to be used for transmitting the command messages to the industrial device, or the like. The industrial controller 102 further transmits the information related to the one or more command messages to the TM 204 prior to transmission of the command messages to the industrial device 108a-108n.

The TM 204 receives the information related to the one or more command messages from the industrial controller 102. Further, the TM 204 may analyze the input data comprising one or more of the device characteristic information of the plurality of industrial devices 108a-108n, the information indicating the state of each industrial device 108a-108n, and the information related to the one or more command messages. Further, the TM 204 estimates the data traffic among the plurality of industrial devices 108a-108n using the input data.

In some embodiments, the TM 204 obtains information related to ongoing communications among the plurality of industrial devices 108a-108n. Further, the TM 204 acquires latency requirement for the one or more command messages from the information related to one or more command messages. The TM 204 further analyzes the information related to ongoing communications among the plurality of industrial devices 108a-108n in accordance with the latency requirement of the one or more command messages. For example, the TM 204 determines that any of the plurality of industrial devices 108a-108n are communicating with other industrial devices 108a-108n. Further, the TM estimates the data traffic among the plurality of industrial devices 108a-108n based on the analysis of the information related to ongoing communications among the plurality of industrial devices 108a-108n in accordance with the latency requirement of the one or more command messages.

The TM 204 transmits 220 the data traffic and the input data to the IM 206. The IM 206 receives the data traffic and the input data from the TM 204. Further, the IM 206 detects presence of at least one object between the industrial devices 108a-108n. The at least one object may causes an interference in transmission of data between the industrial devices 108a-108n. For example, the IM 206 detects whether any object (e.g. a physical component of the industrial device or an external component) is present in the industrial environment that may cause the interference in the transmission of the data. The IM 206 obtains information associated with the at least one object. The information associated with the at least one object comprises one or more of a type of each object and a type of interference caused by each object. The IM 206 determines an impact of the interference of the industrial devices based on the information associated with the object. The IM 206 further identifies a set of frequencies for which the interference is caused by the at least one object. For example, the IM 206 analyses each used frequencies and identifies the set of frequencies which are affected by the interference caused by the at least one object. Further, the IM 206 generates an interference model which indicates that the set of frequencies for which the interference is caused by the at least one object. Thus, these frequencies can be avoided to mitigate the interference.

The IM 206 transmits 222 the interference model to the AS 208. The AS 208 schedules the radio resources for the plurality of industrial devices 108a-108n based on the data traffic and the interference model. For example, the AS 208 may schedule the radio resources by avoiding the set of frequencies. For example, the AS 208 allocates the radio resources for the transmission of the one or more command messages such that that the set of frequencies are avoided.

In some embodiments, the AS 208 estimates a capacity for the command messages indicating the radio resources to be used for transmission of the one or more command messages to the industrial devices 108a-108n. For example, the AS 208 estimates the capacity for the command messages using the information related to the one or more command messages to be transmitted to the industrial devices 108a-108n.

The AS 208 transmits 224 the estimated capacity and information about scheduled radio resources to the industrial controller 102. The industrial controller 102 executes the industrial application to generate one or more updated command messages. For example, the industrial controller 102 analyzes the additional information about the industrial environment based on the estimated capacity and the information about scheduled radio resources to regenerate the command messages. For example, the network node 104 may consider the details about the industrial devices 108a-108n, the state of the industrial devices 108a-108n and details about the command messages in scheduling the radio resources for the transmission of the data. Further, the network node 104 may consider at least one object e.g. physical dimensions and material of an object that could block direct line of sight communication options or use of a module that is known to cause interference in a certain set of radio frequencies so that using those frequencies can be avoided while the module is used.

The industrial controller 102 transmits 226 the one or more updated command messages to the plurality of industrial devices 108a-108n. The command messages result in a set of communication activities among the plurality of industrial devices 108a-108n. Altogether, such use of additional inputs can help networks operate more efficiently and require less resources and enable more effective use of the resources by the network node 104. Further, the IM 206 and the TM 204 observe the resulting command messages and their delivery success to improve the upcoming estimates of the data traffic.

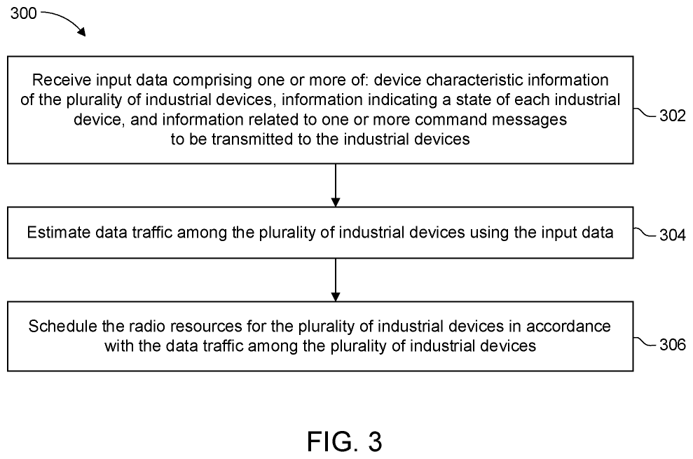

FIG. 3 is a flowchart illustrating example method steps of a method 300 performed by the network node in the wireless communication network for scheduling radio resources for a plurality of industrial devices in the industrial environment.

At step 302, the method 300 comprises receiving input data comprising one or more of device characteristic information of the plurality of industrial devices, information indicating the state of each industrial device, and information related to one or more command messages to be transmitted to the industrial devices. The network node receives the input data from one or more of a repository associated with the industrial environment, each industrial device, and an industrial controller executing an industrial application configured to generate one or more command messages for controlling the industrial device. For example, the network node receives the device characteristic information of the plurality of industrial devices from the repository. The network node receives the information indicating the state from each industrial device. Further, the network node receives the information related to one or more command messages from the industrial controller. Examples of the device characteristic information may include one or more of properties of the industrial devices, a capability of the industrial device to perform the assigned task, a material used in a manufacturing of the industrial device, compatibility of the industrial device with each other, a location of the industrial device, information about a protocol stack of an industrial application executed in an industrial controller controlling the industrial devices, latency requirements for the industrial devices, spectral density of an electromagnetic field produced by the industrial device, or the like. Example of the information indicating the state of each industrial device may comprise one or more of a current location of the industrial device, a connection with each industrial device, and an orientation of the industrial device, or the like. The network node transmits a request message for the input data to one or more of the repository, the plurality of industrial devices, and the industrial controller. Further, the network node receives the input data from one or more of the repository, the plurality of industrial devices, and the industrial controller.

At step 304, the method 300 comprises estimating data traffic among the plurality of industrial devices using the input data. For example, the network node estimates the data traffic among the plurality of industrial devices using one or more of device characteristic information of the plurality of industrial devices, information indicating the state of each industrial device, and information related to one or more command messages to be transmitted to the industrial devices. The data traffic indicates ongoing communication among the plurality of industrial devices.

The step 304 of estimating the data traffic among the plurality of industrial devices using the input data may in some embodiments comprise obtaining information related to ongoing communications among the plurality of industrial devices and acquiring latency requirement for the one or more command messages. Further, the network node analyses the information related to ongoing communications among the plurality of industrial devices in accordance with the latency requirement for the one or more command messages. The network node further estimates the data traffic among the plurality of industrial devices based on the analysis. For example, the network node identifies one or more industrial devices that are currently in the communication with each other.

In some embodiments, the network node detects presence of at least one object between the plurality of industrial devices. The at least one object may cause an interference is transmission of data between the industrial devices. For example, the network node may identify the at least one object in the industrial environment that may cause interference in the transmission of the data between the industrial devices. Further, the network node obtains the information associated with the at least one object. For example, the information associated with the at least one object comprises one or more of a type of each object and a type of interference caused by each object. Further, the network node determines an impact of the interference on the industrial device based on the information associated with the at least one object. For example, the network node determines an intensity of the interference, a type of the interference, or the like based on the information associated with the object. The network node identifies a set of frequencies for which the interference is caused by the at least one object. For example, the network node analyses each used frequencies and identifies the set of frequencies which are affected by the interference caused by the at least one object. Further, the network node schedules the radio resources by avoiding the identified set of frequencies.

At step 306, the method 300 comprises scheduling the radio resources for the plurality of industrial devices in accordance with the data traffic among the plurality of industrial devices. For example, the network node detects the network conditions in view of the data traffic and estimate achievable capacity for the one or more command messages. Further, the network node schedules the radio resources for the plurality of industrial devices based on the achievable capacity for the one or more command messages. For example, the network node allocates the radio resources for the transmission of the one or more command messages in accordance with the data traffic.

The network node intelligently schedules the radio resources by analysing the additional inputs about the industrial environment. For example, the network node considers the details about the industrial devices, the state of the industrial devices 108a-108n and details about the command messages in scheduling the radio resources for the transmission of the command messages. Further, the network node considers at least one object e.g. physical dimensions and material of an object that could block direct line of sight communication options or use of a module (e.g. a robotic arm or a servo) that is known to cause interference in a certain set of radio frequencies so that using those frequencies can be avoided while the module is used. Altogether, such use of additional inputs can help networks operate more efficiently and require less resources and enable more effective use of the radio resources by the network node.

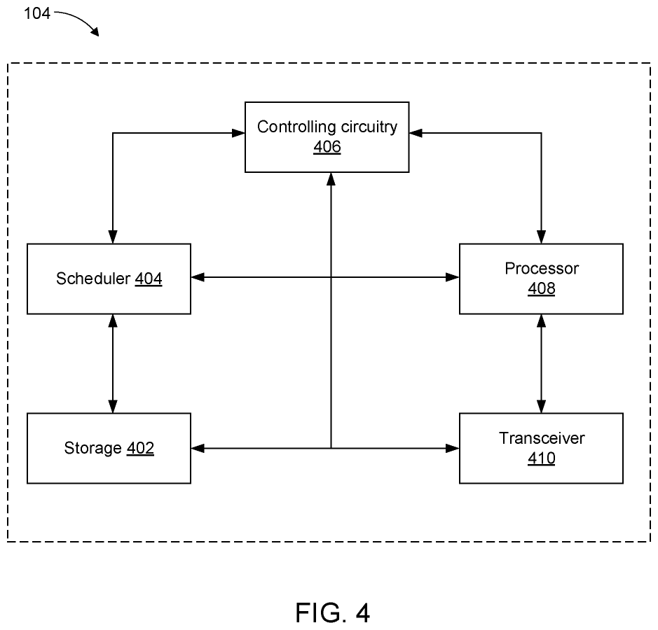

FIG. 4 is an example schematic diagram showing an apparatus 104. The apparatus 104 may e.g. be comprised in a network node. The apparatus 104 is capable of scheduling radio resources for a plurality of industrial devices in an industrial environment and may be configured to cause performance of the method 300 for scheduling radio resources for a plurality of industrial devices in an industrial environment.

According to at least some embodiments of the present invention, the apparatus 104 in FIG. 4 comprises one or more modules. These modules may e.g. be a storage 402, a scheduler 404, a controlling circuitry 406, a processor 408, and a transceiver 410. The controlling circuitry 406, may in some embodiments be adapted to control the above mentioned modules.

The storage 402, the scheduler 404, the processor 408, and the transceiver 410 as well as the controlling circuitry 406, may be operatively connected to each other.

Optionally, the transceiver 410 may be adapted to receive input data from one or more of the repository associated with the industrial environment, each industrial device, and the industrial controller executing an industrial application configured to generate one or more command messages for controlling the industrial device.

As described above, the various ways of scheduling radio resources for a plurality of industrial devices in an industrial environment, a few of which have been mentioned above in connection to the explanation of FIG. 3.

The controlling circuitry 406 may be adapted to control the steps as executed by the network node 102. For example, the controlling circuitry 406 may be adapted to estimate the data traffic among the plurality of industrial devices using the input data (as described above in conjunction with the method 300 and FIG. 3).

Further, the processor 408 is adapted to perform the method 300 and FIG. 3 in conjunction with the controlling circuitry 406.

Furthermore, the multiplexer 404 is adapted to schedule the radio resources for the plurality of industrial devices in accordance with the data traffic among the plurality of industrial devices.

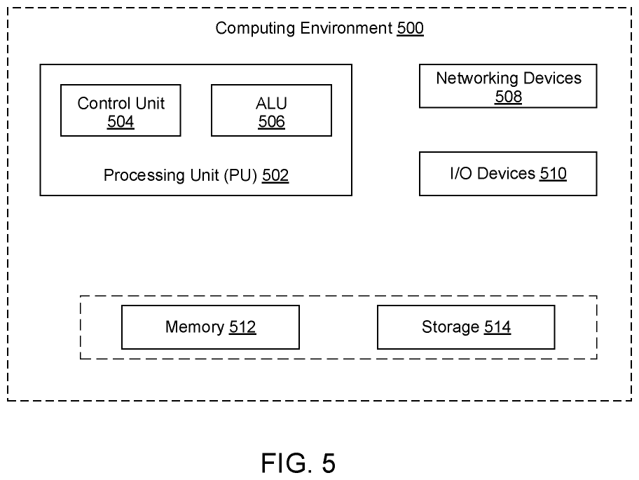

FIG. 5 illustrates an example computing environment 500 implementing a method and the network node and the UE as described in FIG. 3. As depicted in FIG. 5, the computing environment 500 comprises at least one processing unit 502 that is equipped with a control unit 504 and an Arithmetic Logic Unit (ALU) 506, a plurality of networking devices 508 and a plurality Input output, I/O devices 510, a memory 512, and a storage 514. The processing unit 502 may be responsible for implementing the method described in FIG. 3. For example, the processing unit 502 may in some embodiments be equivalent to the processor of the network node as described above in conjunction with the FIGS. 1-4. The processing unit 502 is capable of executing software instructions stored in memory 512. The processing unit 502 receives commands from the control unit 504 in order to perform its processing. Further, any logical and arithmetic operations involved in the execution of the instructions are computed with the help of the ALU 506.

The computer program is loadable into the processing unit 502, which may, for example, be comprised in an electronic apparatus (such a network node). When loaded into the processing unit 502, the computer program may be stored in the memory 512 associated with or comprised in the processing unit 502. According to some embodiments, the computer program may, when loaded into and run by the processing unit 502, cause execution of method steps according to, for example, the method illustrated in FIG. 3 or otherwise described herein.

The overall computing environment 500 may be composed of multiple homogeneous and/or heterogeneous cores, multiple CPUs of different kinds, special media and other accelerators. Further, the plurality of processing unit 502 may be located on a single chip or over multiple chips.

The algorithm comprising of instructions and codes required for the implementation are stored in either the memory 512 or the storage 514 or both. At the time of execution, the instructions may be fetched from the corresponding memory 512 and/or storage 514, and executed by the processing unit 502.

In case of any hardware implementations various networking devices 508 or external I/O devices 510 may be connected to the computing environment to support the implementation through the networking devices 508 and the I/O devices 510.

The embodiments disclosed herein can be implemented through at least one software program running on at least one hardware device and performing network management functions to control the elements. The elements shown in FIG. 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for scheduling radio resources for a plurality of industrial devices in an industrial environment, the method being performed by a network node in a wireless communication network, the method comprising:
receiving input data comprising one or more of: device characteristic information of the plurality of industrial devices, information indicating a state of each industrial device, and information related to one or more command messages to be transmitted to the industrial devices;
estimating data traffic among the plurality of industrial devices using the input data; and
scheduling the radio resources for the plurality of industrial devices in accordance with the data traffic among the plurality of industrial devices.

2. The method according to claim 1, wherein the input data is received from one or more of:
a repository associated with the industrial environment;
each industrial device; and
an industrial controller executing an industrial application configured to generate the one or more command messages for controlling the industrial device.

3. The method according to claim 1, wherein the device characteristic information comprises one or more of:
one or more properties of the industrial devices;
a capability of each industrial device to perform an assigned task;
a material used in a manufacturing of the industrial device;
compatibility of the industrial devices with each other;
a location of the industrial device;
information about a protocol stack of an industrial application executed in an industrial controller controlling the industrial devices;
latency requirement for the industrial devices; and
spectral density of an electromagnetic field produced by the industrial device.

4. The method according to claim 1, wherein the information indicating the state of each industrial device comprises one or more of:
a current location of the industrial device,
a connection with each industrial device, and
an orientation of the industrial device.

5. The method according to claim 1, wherein the step of receiving the input data comprises:
transmitting a request message for the input data to one or more of: the repository, the plurality of industrial devices, and the industrial controller; and
receiving the input data in response to the request message.

6. The method according to claim 1, wherein the step of estimating the data traffic among the plurality of industrial devices using the input data comprises:
obtaining information related to ongoing communications among the plurality of industrial devices;
acquiring latency requirement for the one or more command messages;
analyzing the information related to ongoing communications among the plurality of industrial devices in accordance with the latency requirement for the one or more command messages; and
estimating the data traffic among the plurality of industrial devices based on the analysis.

7. The method according to claim 1, wherein the step of scheduling the radio resources for the plurality of industrial devices in accordance with the data traffic among the plurality of industrial devices comprises:
detecting presence of at least one object between the plurality of industrial devices, the at least one object causing an interference in transmission of data between the industrial devices;
obtaining information associated with the at least one object, the information comprising one or more of: a type of each object and a type of interference caused by each object;
determining an impact of the interference on the industrial devices based on the information associated with the object;
identifying a set of frequencies for which the interference is caused by the at least one object; and
scheduling the radio resources by avoiding the identified set of frequencies.

8. An apparatus of a network node configured to operate in a wireless communication network for scheduling radio resources for a plurality of industrial devices in an industrial environment, the apparatus comprising controlling circuitry configured to cause:
reception of input data comprising one or more of: device characteristic information of the plurality of industrial devices, information indicating a state of each industrial device, and information related to one or more command messages to be transmitted to the industrial devices;
estimation of data traffic among the plurality of industrial devices using the input data; and
scheduling of the radio resources for the plurality of industrial devices in accordance with the data traffic among the plurality of industrial devices.

9. The apparatus according to claim 8, wherein the input data is received from one or more of:
a repository associated with the industrial environment;
each industrial device; and
an industrial controller executing an industrial application configured to generate the one or more command messages for controlling the industrial device.

10. The apparatus according to claim 8, wherein the device characteristic information comprises one or more of:
one or more properties of the industrial devices;
a capability of each industrial device to perform an assigned task;
a material used in a manufacturing of the industrial device;
compatibility of the industrial devices with each other;
a location of the industrial device;
information about a protocol stack of an industrial application executed in an industrial controller controlling the industrial devices;
latency requirement for the industrial devices; and
spectral density of an electromagnetic field produced by the industrial device.

11. The apparatus according to claim 8, wherein the information indicating the state of each industrial device comprises one or more of:
a current location of the industrial device,
cu, and
an orientation of the industrial device.

12. The apparatus according to claim 8, wherein the controlling circuitry is configured to cause the step of receiving the input data by causing:
transmission of a request message for the input data to one or more of: the repository, the plurality of industrial devices, and the industrial controller; and
reception of the input data in response to the request message.

13. The apparatus according to claim 8, wherein the controlling circuitry is configured to cause the step of estimating the data traffic among the plurality of industrial devices using the input data by causing:
obtaining of information related to ongoing communications among the plurality of industrial devices;
acquisition of latency requirement for the one or more command messages;
analyzing of the information related to ongoing communications among the plurality of industrial devices in accordance with the latency requirement for the one or more command messages; and
estimation of the data traffic among the plurality of industrial devices based on the analysis.

14. The apparatus according to claim 8, wherein the controlling circuitry is configured to cause the step of scheduling the radio resources for the plurality of industrial devices in accordance with the data traffic among the plurality of industrial devices by causing:
detection of presence of at least one object between the plurality of industrial devices, the at least one object causing an interference in transmission of data between the industrial devices;
obtaining of information associated with the at least one object, the information comprising one or more of: a type of each object and a type of interference caused by each object;
determination of an impact of the interference on the industrial devices based on the information associated with the object;
identification of a set of frequencies for which the interference is caused by the at least one object; and
scheduling of the radio resources by avoiding the identified set of frequencies.

15. A network node comprising the apparatus of claim 8.

16. A computer program product comprising a non-transitory computer readable medium, having thereon a computer program comprising program instructions, the computer program is loadable into a data processing unit and configured to cause execution of the method of claim 1 when the computer program is run by the data processing unit.
